(19) United States
(12) Patent Application Publication
(10) Pub. No.: US 2022/0024086 A1
(43) Pub. Date: Jan. 27, 2022

(54) Rubber injection guide plate, vulcanized rubber boot and transfer molding mold, manufacturing equipment and manufacturing method thereof

(71) Applicant: EAST ROCK UNION LIMITED, Beijing (CN)

(72) Inventors: Jue WANG, Beijing (CN); Yongjiang ZONG, Beijing (CN)

(21) Appl. No.: 17/299,891

(22) PCT Filed: Nov. 4, 2019
(86) PCT No.: PCT/CN2019/115413

§ 371 Date: Jun. 4, 2021

(51) Int. Cl. B29C 45/02; B29D 35/00; B29D 35/02

(52) U.S. Cl. CPC B29C 45/02; B29D 35/02; B29D 35/0018

(57) ABSTRACT

The present invention provides a rubber injection guide plate for guiding injection of unvulcanized mixed rubber, comprising a plate body, wherein the plate body is provided with: a rubber injection port to be connected with an external injection head to inject unvulcanized mixed rubber; and an annular rubber injection channel for leading the externally injected unvulcanized mixed rubber out in an annular distribution manner.

### FIELD OF THE INVENTION

The present invention relates to a rubber injection guide plate, a vulcanized rubber boot and a transfer molding mold, manufacturing equipment and manufacturing method thereof.

### BACKGROUND OF THE INVENTION

Vulcanized rubber boots have been widely used in field operations such as fishing, as well as worker safety and fashion. The vulcanized rubber boots have high requirements for waterproof performance.

However, it is difficult to achieve overall transfer molding in the manufacturing industry of vulcanized rubber boots at present due to the poor flow characteristics of rubber, different from that of PVC materials or the like, and semi-automated production lines are dominant in the industry.

In a semi-automatic production line, rubber sheets having predetermined shapes and thicknesses are manufactured by the processes of mixing, extrusion, calendering etc. On the production line, a worker puts a boot lining on a last, and firmly applies the pre-manufactured rubber sheets of various shapes to the boot lining in a predetermined manner to form a tube of a vulcanized rubber boot. Depending on different processes, a pre-manufactured sole can be cemented to the tube of the vulcanized rubber boot before or after vulcanization to complete the overall manufacturing. In order to detect air leakage, special equipment is required to manually test the tube or the entire vulcanized rubber boot. Generally, since the tube is formed by manually stacking the rubber sheets, it is common that the vulcanized rubber boot manufactured in this way has parts with water leakage. Some parts are difficult to repair in the subsequent process, so the scrap rate is quite high, which greatly increases the production cost of vulcanized rubber boots. Therefore, an improved production process for vulcanized rubber boots is required.

### SUMMARY OF THE INVENTION

According to one aspect of the invention, there is provided a rubber injection guide plate for guiding injection of unvulcanized mixed rubber, comprising a plate body, wherein the plate body is provided with: a rubber injection port to be connected with an external injection head to inject unvulcanized mixed rubber; and an annular rubber injection channel for leading the externally injected unvulcanized mixed rubber out in an annular distribution manner.

Preferably, the plate body is further provided with a distribution chamber, and the distribution chamber is connected with the rubber injection port through a rubber injection channel and connected with the annular rubber injection channel through a diversion channel.

Preferably, a plurality of diversion channels are provided, and each diversion channel connects the distribution chamber to the annular rubber injection channel; and preferably, four diversion channels are provided, which are spaced around the distribution chamber.

Preferably, the rubber injection port is disposed on a side face of the plate body, and the distribution chamber is disposed in the middle of the plate body.

Preferably, the annular rubber injection channel is an annular outlet formed in the bottom of the plate body, and preferably, the shape enclosed by the annular outlet corresponds to the annular shape of the bottom of a tube of a vulcanized rubber boot.

Preferably, wherein the annular rubber injection channel is formed as a continuous annular outlet.

Preferably, the annular rubber injection channel is formed as a non-continuous annular outlet; and preferably, the annular rubber injection channel has thereon a plurality of circular port outlets evenly spaced apart.

According to another aspect of the invention, there is provided a transfer molding mold for a vulcanized rubber boot, comprising: a tube mold, having an inner cavity corresponding to a tube of the vulcanized rubber boot; a last mold, which has a shape corresponding to the tube of the vulcanized rubber boot, and is suitable for installation into the inner cavity of the tube mold to form a transfer molding cavity between the wall of the inner cavity of the tube mold and the outer surface of the last mold; and a rubber injection guide plate suitable for installation on the tube mold to guide injection of unvulcanized mixed rubber, comprising a plate body, wherein the plate body is provided with: a rubber injection port to be connected with an external injection head to inject unvulcanized mixed rubber; and an annular rubber injection channel for leading the externally injected unvulcanized mixed rubber into the transfer molding cavity in an annular distribution manner.

Preferably, the tube mold comprises a left tube mold and a right tube mold that can be mounted to match each other.

Preferably, the tube mold comprises a left tube mold, a right tube mold, and a rear tube mold that can be mounted to match each other.

Preferably, the tube mold comprises a left tube mold, a right tube mold, and a front tube mold that can be mounted to match each other.

Preferably, the top of the tube mold and the bottom of the rubber injection guide plate have combining parts that match each other, and the rubber injection guide plate is suitable for being closed to the top of the tube mold through the combining parts.

Preferably, further comprising: an outsole mold, having an outsole rubber injection port and an outsole mold cavity corresponding to the shape of the sole of the vulcanized rubber boot, and being used to transfer mold the sole of the vulcanized rubber boot, wherein the outsole mold has an outsole combining part, and is suitable for being closed to the top of the tube mold and the top of the rubber injection guide plate through the outsole combining part.

Preferably, the plate body is further provided with a distribution chamber, and the distribution chamber is connected with the rubber injection port through a rubber injection channel and connected with the annular rubber injection channel through a diversion channel.

Preferably, a plurality of diversion channels are provided, and each diversion channel connects the distribution chamber to the annular rubber injection channel; and preferably, four diversion channels are provided, which are spaced around the distribution chamber.

Preferably, the rubber injection port is disposed on a side face of the plate body, and the distribution chamber is disposed in the middle of the plate body.

Preferably, the annular rubber injection channel is an annular outlet formed in the bottom of the plate body, and preferably, the shape enclosed by the annular outlet corresponds to the annular shape of the bottom of a tube of a vulcanized rubber boot.

Preferably, the annular rubber injection channel is formed as a continuous annular outlet.

Preferably, the annular rubber injection channel is formed as a non-continuous annular outlet; and preferably, the annular rubber injection channel has a plurality of circular port outlets evenly spaced apart.

According to another aspect of the invention, there is provided a transfer molding mold for a vulcanized rubber boot, comprising: a tube mold, having an inner cavity corresponding to a tube of the vulcanized rubber boot, wherein the top of the tube mold is provided with an annular rubber injection diversion channel, and the annular rubber injection channel is communicated with the inner cavity through a diversion channel; a last mold, which has a shape corresponding to the tube of the vulcanized rubber boot, and is suitable for installation into the inner cavity of the tube mold to form a transfer molding cavity between the wall of the inner cavity of the tube mold and the outer surface of the last mold; and a rubber injection guide plate suitable for installation on the tube mold to guide injection of unvulcanized mixed rubber, comprising a plate body, wherein the plate body is provided with: a rubber injection port to be connected with an external injection head to inject unvulcanized mixed rubber; and an annular primary splitting channel, which is connected with the rubber injection port, and connected with the annular rubber injection channel on the tube mold through a diversion channel.

Preferably, the tube mold comprises a left tube mold and a right tube mold that can be mounted to match each other.

Preferably, the tube mold comprises a left tube mold, a right tube mold, and a rear tube mold that can be mounted to match each other.

Preferably, the tube mold comprises a left tube mold, a right tube mold, and a front tube mold that can be mounted to match each other.

Preferably, the top of the tube mold and the bottom of the rubber injection guide plate have combining parts that match each other, and the rubber injection guide plate is suitable for being closed to the top of the tube mold through the combining parts.

Preferably, further comprising: an outsole mold, having an outsole rubber injection port and an outsole mold cavity corresponding to the shape of the sole of the vulcanized rubber boot, and being used to transfer mold the sole of the vulcanized rubber boot, wherein the outsole mold has an outsole combining part, and is suitable for being closed to the top of the tube mold and the top of the rubber injection guide plate through the outsole combining part.

Preferably, the plate body is further provided with a distribution chamber, and the distribution chamber is connected with the rubber injection port through a rubber injection channel and connected with the primary splitting channel through a diversion channel.

According to another aspect of the invention, there is provided a transfer molding equipment for a vulcanized rubber boot, comprising: the transfer molding mold according to any one of the above aspects; a high-pressure injection mechanism for pressurizing and injecting the prepared unvulcanized mixed rubber into the rubber injection port of the transfer molding mold; a mold moving mechanism for moving various parts of the transfer molding mold according to a preset program; and a control mechanism for controlling the operations of the mold moving mechanism and the high-pressure injection mechanism.

Preferably, further comprising a heater for heating the unvulcanized mixed rubber.

According to another aspect of the invention, there is provided a method for manufacturing a vulcanized rubber boot by using the transfer molding equipment according to any one of the above aspects, comprising: separating various parts of the tube mold, and moving the last mold covered with a boot lining to be between the various parts of the tube mold; closing the various parts of the tube mold to accommodate and locate the last mold at an appropriate position in the various parts of the tube mold, thus forming the transfer molding cavity; locating and fixing the rubber injection guide plate to the top of the tube mold; injecting rubber into the rubber injection guide plate, and thereby injecting the rubber into the transfer molding cavity between the tube mold and the last mold through the rubber injection guide plate; and vulcanizing the injected unvulcanized mixed rubber.

Preferably, before vulcanizing the injected unvulcanized mixed rubber, the method further comprises the following steps: closing the outsole mold, and injecting rubber into the outsole rubber injection port of the outsole mold to form a sole; withdrawing the rubber injection guide plate from the tube mold, and combining the outsole mold with the tube mold; and vulcanizing the overall tube and sole to form a unitary vulcanized rubber boot.

Preferably, further comprising: withdrawing the outsole mold after vulcanization, opening the tube mold, and withdrawing the vulcanized rubber boot from the transfer molding equipment together with the last mold.

Preferably, further comprising: separating the vulcanized rubber boot from the last mold through an air pressure device.

In the traditional manufacturing method, since the fluidity of rubber (such as unvulcanized mixed rubber) is very poor, if injection molding or transfer molding is performed, the pressure in the mold will be very high. Even if the fluidity is improved by improving the formulation of the unvulcanized mixed rubber, the pressure in the mold is still very high. This may even cause the last mold to deflect or shift, so that an effective transfer molding cavity cannot be formed. In addition, under great pressure, the boot lining covering the last mold will also be twisted, folded, or even broken due to extrusion. However, through the guide plate according to the present invention, the unvulcanized mixed rubber will be uniformly guided into the transfer molding cavity under pressure. Because the distribution of pressure is relatively uniform, the last mold will not deflect or shift, and the boot lining will not be impacted greatly. With the guide plate according to the present invention and related mold and equipment, a unitary molded vulcanized rubber boot can be manufactured, comprising a tube, a sole and a boot lining molded by integrally transfer molding.

Although the guide plate is described to be applied to a transfer molding process according to the embodiments of the present invention, it is also applicable to an injection molding process; and the protection scope of the present invention also intends to cover such applications.

### BRIEF DESCRIPTION OF THE DRAWINGS

The present invention will be more fully understood through the following detailed descriptions and the accompanying drawings, in which similar elements are numbered in a similar manner, wherein:

FIGS. 1a-1e are schematic diagrams of a rubber injection guide plate according to the present invention.

FIG. 2 is a schematic diagram of a transfer molding mold according to the present invention.

FIG. 3 is another schematic diagram of the transfer molding mold according to the present invention, showing a state of closing left and right tube molds.

FIG. 4 is another schematic diagram of the transfer molding mold according to the present invention, showing a state of closing all molds.

### DETAILED DESCRIPTION OF THE EMBODIMENTS

The technical solution of the present invention will be further described in detail below through embodiments in combination with the accompanying drawings.

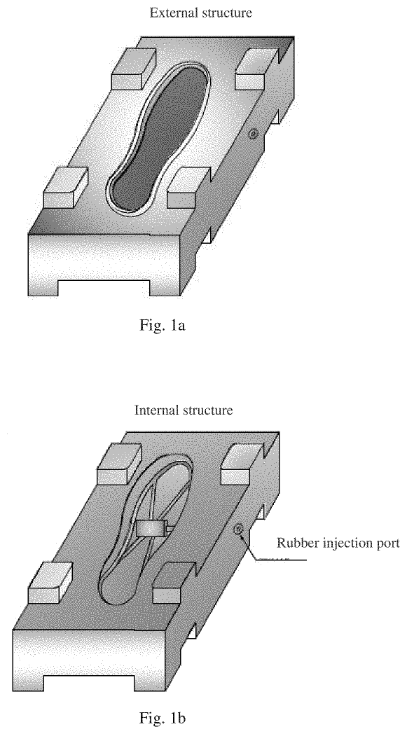

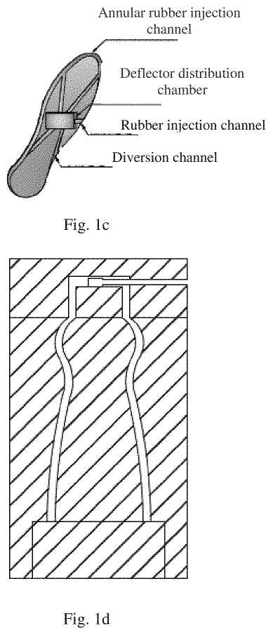

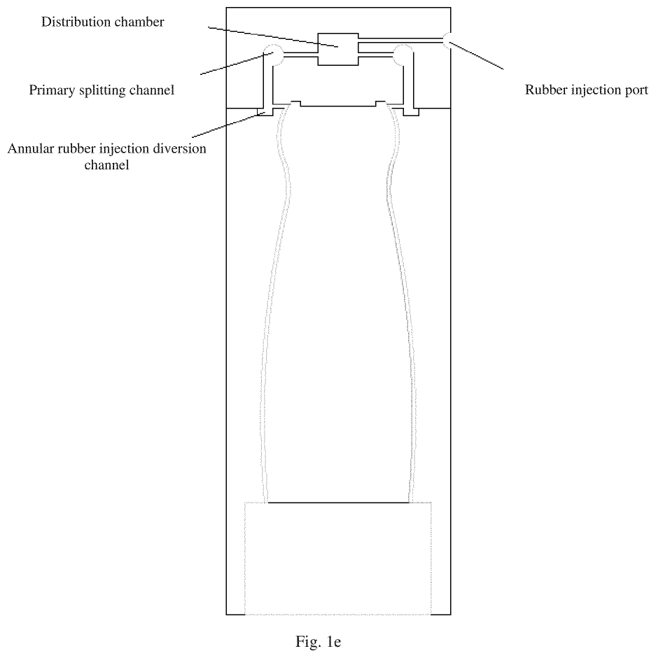

In order to solve the problem that it is difficult to achieve injection-molded or transfer molded rubber boots (for example, unitary molded vulcanized rubber boots) due to poor fluidity of rubber (for example, unvulcanized mixed rubber), the inventors of the present invention manufactured a rubber injection guide plate for guiding injection of unvulcanized mixed rubber, as well as a vulcanized rubber boot using the rubber injection guide plate and a transfer molding mold, production line and production process thereof. The unitary vulcanized rubber boots produced by using the equipment or process also fall within the protection scope of the present invention. As shown in FIGS. 1a-1e, according to one aspect of the present invention, a rubber injection guide plate for guiding injection of unvulcanized mixed rubber is provided, comprising a plate body. The plate body is generally square, and is made of a material suitable for manufacturing a high-pressure mold.

FIG. 1a shows an external structure of the rubber injection guide plate, FIG. 1b shows a schematic diagram of an internal structure of the rubber injection guide plate, FIG. 1c shows a schematic diagram of a cavity and channels of the rubber injection guide plate, and FIG. 1d shows a schematic diagram of matching the rubber injection guide plate with other molds at a mounting position. FIG. 1e shows a schematic diagram of a rubber injection guide plate and a tube mold according to another embodiment of the present invention.

The plate body may be provided with: a rubber injection port to be connected with an external injection head to inject unvulcanized mixed rubber; and an annular rubber injection channel for leading the externally injected unvulcanized mixed rubber out in an annular distribution manner. As shown in FIG. 1d, the unvulcanized mixed rubber led out is introduced into other molds, such as a tube mold for producing rubber boots.

The plate body is also provided with a distribution chamber, and the distribution chamber is connected with the rubber injection port through a rubber injection channel and connected with the annular rubber injection channel through a diversion channel. Providing the distribution chamber can be more conducive to smoothly lead the unvulcanized mixed rubber out.

One or a plurality of diversion channels may be provided, and preferably, a plurality of diversion channels are provided, each diversion channel connecting the distribution chamber to the annular rubber injection channel. Preferably, four diversion channels are distributed around the distribution chamber. The plurality of diversion channels help the unvulcanized mixed rubber to flow more smoothly from the distribution chamber to the annular channel, and help to reduce the pressure.

As shown in the figures, the rubber injection port may be disposed on a side face of the plate body, and the distribution chamber is disposed in the middle of the plate body.

As shown in FIG. 1a, the annular rubber injection channel is an annular outlet formed in the bottom of the plate body, and the shape enclosed by the annular outlet corresponds to the annular shape of the bottom of a tube of a vulcanized rubber boot.

In some embodiments, the annular rubber injection channel is formed as a continuous annular outlet. In some other embodiments, the annular rubber injection channel is formed as a non-continuous annular outlet, for example, the annular rubber injection channel has a plurality of circular port outlets evenly spaced apart. In these ways, the unvulcanized mixed rubber can be injected into the tube mold in an annular or substantially annular manner.

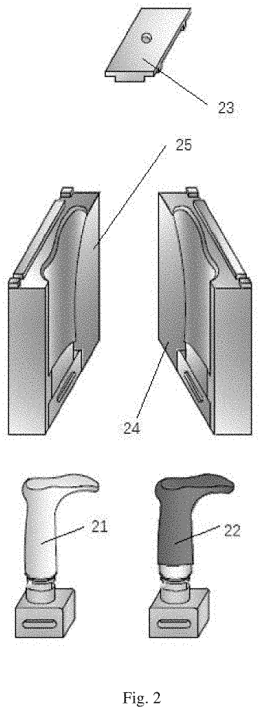

The guide plate may cooperate with other molds (for example, a tube mold, an outsole mold) to form a transfer molding mold for vulcanized rubber boots according to another aspect of the present invention. FIG. 2 shows a tube mold, a last (or shoe tree) mold and an outsole mold that may cooperate with the guide plate.

According to another embodiment of the present invention, as shown in FIG. 1e, the top of the tube mold is provided with an annular rubber injection diversion channel, and the annular rubber injection channel is communicated with an inner cavity (or a transfer molding cavity described below) of the tube mold through diversion channels. The rubber injection guide plate may comprise a plate body, wherein the plate body is provided with: a rubber injection port to be connected with an external injection head to inject unvulcanized mixed rubber; and an annular primary splitting channel, connected with the rubber injection port, and connected with the annular rubber injection channel on the tube mold through a diversion channel. Preferably, the plate body is further provided with a distribution chamber, and the distribution chamber is connected with the rubber injection port through a rubber injection channel and connected with the primary splitting channel through a diversion channel.

In this embodiment, the unvulcanized mixed rubber injected by pressure is split twice, namely from the rubber injection port (or the distribution chamber) to the annular primary splitting channel, and from the primary splitting channel to the annular rubber injection channel at the top of the tube mold. By splitting twice, the unvulcanized mixed rubber can be more uniformly distributed and injected into the transfer molding cavity described below under lower pressure. The transfer molding mold may comprise a tube mold as shown in FIG. 2, having an inner cavity corresponding to a tube of a vulcanized rubber boot; a last mold 21 or 22, which has a shape corresponding to the tube of the vulcanized rubber boot, and is suitable for installation into the inner cavity of the tube mold to form a transfer molding cavity between the wall of the inner cavity of the tube mold and the outer surface of the last mold; and the rubber injection guide plate for guiding injection of unvulcanized mixed rubber, which is used to introduce the externally injected unvulcanized mixed rubber into the transfer molding cavity in an annular distribution manner.

The last mold 21 represents a last mold not covered with a boot lining, and the last mold 22 represents a last mold covered with a boot lining. In order to prevent the unvulcanized mixed rubber from penetrating into the interior of the boot lining through textile void under very high pressure in the transfer molding process, the material of the boot lining may be, for example, composed of two layers of fabric and a heat-resisting insulation material (for example, neoprene) compounded between the two layers of fabric.

As shown in FIG. 2, the tube mold comprises a left tube mold 25 and a right tube mold 24 that can be fitted to each other. The transfer molding mold may further comprise an outsole mold 23 for transfer molding a sole of a rubber boot.

In other embodiments, the tube mold may comprise three or more parts that can match each other and be fitted into a whole. For example, the tube mold comprises a left tube mold, a right tube mold, and a rear tube mold that can be fitted to each other; or the tube mold comprises a left tube mold, a right tube mold, and a front tube mold that can be fitted to each other. Their combination is similar to that in the embodiment of FIG. 2.

The top of the tube mold and the bottom of the rubber injection guide plate have combining parts that match each other, and the rubber injection guide plate is suitable for being closed to the top of the tube mold through the combining parts. For example, protruding blocks on four sides of the top of the left tube mold and the right tube mold in FIG. 2 and recessed parts at the bottom of the guide plate in FIG. 1 can match with each other, so that the guide plate and the tube mold can be accurately positioned with respect to each other.

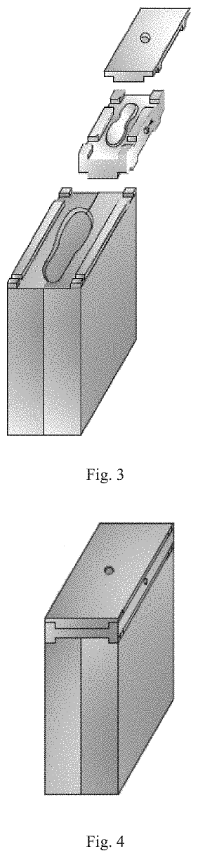

FIG. 3 shows the guide plate to be positioned to the closed tube mold, and FIG. 4 shows that the outsole mold, the guide plate and the tube mold are fitted each other to form an integrated mold. As shown in the figures, the outsole mold has an outsole rubber injection port and an outsole mold cavity corresponding to the shape of the sole of the vulcanized rubber boot, and is used to transfer mold the sole of the vulcanized rubber boot. The outsole mold has an outsole combining part, and is suitable for being closed to the top of the tube mold and the top of the rubber injection guide plate through the outsole combining part. As shown in FIG. 3, the outsole combining part is, for example, a recessed part corresponding to the protruding blocks on the top of the tube mold and the protruding blocks on the top of the guide plate, and can thus be combined with the tube mold or the guide plate according to needs.

The guide plate of the transfer molding mold may have any features described in conjunction with FIGS. 1a-1d, and the details are not described herein again.

According to another aspect of the present invention, a transfer molding equipment for a vulcanized rubber boot is provided, comprising: the transfer molding mold as described above; a high-pressure injection mechanism for pressurizing and injecting the prepared unvulcanized mixed rubber into the rubber injection port of the transfer molding mold; a mold moving mechanism for moving various parts of the transfer molding mold according to a preset program; and a control mechanism for controlling the operations of the mold moving mechanism and the high-pressure injection mechanism.

The transfer molding equipment may further comprise a heater for heating the unvulcanized mixed rubber.

The operation of the transfer molding equipment according to the present invention can refer to the following description of the manufacturing process or method.

According to another aspect of the present invention, a method for manufacturing a vulcanized rubber boot by using the above transfer molding equipment is provided. The method may comprise the following steps:

1. The left tube mold 25 and the right tube mold 24 are separated, and the last mold 22 covered with the boot lining is moved to be between the left tube mold 25 and the right tube mold 24;

2. The left tube mold 25 and the right tube mold 24 are closed to accommodate and locate the last mold 22 covered with the boot lining at an appropriate position in the left tube mold 25 and the right tube mold 24, thus forming the transfer molding cavity;

3. The rubber injection guide plate is located and fixed to the top of the tube mold;

4. Rubber is injected into the rubber injection guide plate, and thereby injected into the transfer molding cavity between the tube mold and the last mold through the annular rubber injection channel of the rubber injection guide plate;

5. The outsole mold is closed, and rubber is injected into the outsole rubber injection port of the outsole mold to form a sole;

6. The rubber injection guide plate is withdrawn from the tube mold, and the outsole mold is closed with the tube mold; and

7. The overall tube and sole are vulcanized to form a unitary vulcanized rubber boot.

In some embodiments, an integrally formed tube of the unitary vulcanized rubber boot may need to be manufactured, and then the injected unvulcanized mixed rubber may be vulcanized after step 4. The sole of the boot can be integrated with the tube in other ways.

In the above process, the transfer molding cavity is formed by the space between the inner surface of the tube mold and the outer surface of the boot lining covering the last mold, and can be positioned by a square positioning block at the bottom of the last mold and a corresponding positioning feature of the tube mold, or positioned by other relevant positioning features on the transfer molding equipment.

After the unitary vulcanized rubber boot is formed, the method may further comprise the following steps:

8. The outsole mold is withdrawn after vulcanization, the tube mold is opened, and the vulcanized rubber boot is withdrawn from the transfer molding equipment together with the last mold; and

9. The vulcanized rubber boot is separated from the last mold through an air pressure device.

According to another aspect of the present invention, an integrally formed unitary vulcanized rubber boot is provided, comprising a tube, a sole and a boot lining molded by integrally transfer molding. The unitary vulcanized rubber boot is manufactured by the method described above.

The mold and manufacturing method according to the present invention are not limited to the manufacturing of vulcanized rubber boots. In fact, the inventors of the present invention found in further research that the mold and manufacturing method according to the present invention can also be used to manufacture other rubber shoes, with the advantage of one-time molding.

The embodiments of the present invention are not limited to the above embodiments. Persons of ordinary skill in the art may make various changes and improvements to the present invention in form and details without departing from the spirit and scope of the present invention, and these changes and improvements are considered to be within the protection scope of the present invention.

1-32. (canceled)

33. A rubber injection guide plate for guiding injection of unvulcanized mixed rubber, comprising a plate body, wherein the plate body is provided with:
a rubber injection port to be connected with an external injection head to inject unvulcanized mixed rubber; and
an annular rubber injection channel for leading the externally injected unvulcanized mixed rubber out in an annular distribution manner.

34. The rubber injection guide plate according to claim 33, wherein the plate body is further provided with a distribution chamber, and the distribution chamber is connected with the rubber injection port through a rubber injection channel and connected with the annular rubber injection channel through a diversion channel.

35. The rubber injection guide plate according to claim 34, wherein a plurality of diversion channels are provided, and each diversion channel connects the distribution chamber to the annular rubber injection channel.

36. The rubber injection guide plate according to claim 33, wherein the rubber injection port is disposed on a side face of the plate body, and the distribution chamber is disposed in the middle of the plate body.

37. The rubber injection guide plate according to claim 33, wherein the annular rubber injection channel is an annular outlet formed in the bottom of the plate body, and preferably, the shape enclosed by the annular outlet corresponds to the annular shape of the bottom of a tube of a vulcanized rubber boot.

38. The rubber injection guide plate according to claim 33, wherein the annular rubber injection channel is formed as a continuous annular outlet or a non-continuous annular outlet.

39. A transfer molding mold for a vulcanized rubber boot, comprising:
a tube mold, having an inner cavity corresponding to a tube of the vulcanized rubber boot;
a last mold, which has a shape corresponding to the tube of the vulcanized rubber boot, and is suitable for installation into the inner cavity of the tube mold to form a transfer molding cavity between the wall of the inner cavity of the tube mold and the outer surface of the last mold; and
a rubber injection guide plate suitable for installation on the tube mold to guide injection of unvulcanized mixed rubber, comprising a plate body, wherein the plate body is provided with:
a rubber injection port to be connected with an external injection head to inject unvulcanized mixed rubber; and
an annular rubber injection channel for leading the externally injected unvulcanized mixed rubber into the transfer molding cavity in an annular distribution manner.

40. The transfer molding mold according to claim 39, wherein the tube mold comprises a left tube mold and a right tube mold that can be mounted to match each other; or the tube mold comprises a left tube mold, a right tube mold, and a rear tube mold that can be mounted to match each other; or the tube mold comprises a left tube mold, a right tube mold, and a front tube mold that can be mounted to match each other.

41. The transfer molding mold according to claim 39, wherein the top of the tube mold and the bottom of the rubber injection guide plate have combining parts that match each other, and the rubber injection guide plate is suitable for being closed to the top of the tube mold through the combining parts.

42. The transfer molding mold according to claim 39, further comprising:
an outsole mold, having an outsole rubber injection port and an outsole mold cavity corresponding to the shape of the sole of the vulcanized rubber boot, and being used to transfer mold the sole of the vulcanized rubber boot, wherein the outsole mold has an outsole combining part, and is suitable for being closed to the top of the tube mold and the top of the rubber injection guide plate through the outsole combining part.

43. The transfer molding mold according to claim 39, wherein the plate body is further provided with a distribution chamber, and the distribution chamber is connected with the rubber injection port through a rubber injection channel and connected with the annular rubber injection channel through a diversion channel.

44. The transfer molding mold according to claim 43, wherein a plurality of diversion channels are provided, and each diversion channel connects the distribution chamber to the annular rubber injection channel; and preferably, four diversion channels are provided, which are spaced around the distribution chamber.

45. The transfer molding mold according to claim 39, wherein the rubber injection port is disposed on a side face of the plate body, and the distribution chamber is disposed in the middle of the plate body.

46. The transfer molding mold according to claim 39, wherein the annular rubber injection channel is an annular outlet formed in the bottom of the plate body, and preferably, the shape enclosed by the annular outlet corresponds to the annular shape of the bottom of a tube of a vulcanized rubber boot.

47. The transfer molding mold according to claim 46, wherein the annular rubber injection channel is formed as a continuous annular outlet.

48. The transfer molding mold according to claim 46, wherein the annular rubber injection channel is formed as a non-continuous annular outlet; and preferably, the annular rubber injection channel has a plurality of circular port outlets evenly spaced apart.

49. A transfer molding mold for a vulcanized rubber boot, comprising:
a tube mold, having an inner cavity corresponding to a tube of the vulcanized rubber boot, wherein the top of the tube mold is provided with an annular rubber injection diversion channel, and the annular rubber injection channel is communicated with the inner cavity through a diversion channel;
a last mold, which has a shape corresponding to the tube of the vulcanized rubber boot, and is suitable for installation into the inner cavity of the tube mold to form a transfer molding cavity between the wall of the inner cavity of the tube mold and the outer surface of the last mold; and
a rubber injection guide plate suitable for installation on the tube mold to guide injection of unvulcanized mixed rubber, comprising a plate body, wherein the plate body is provided with:
a rubber injection port to be connected with an external injection head to inject unvulcanized mixed rubber; and
an annular primary splitting channel, which is connected with the rubber injection port, and connected with the annular rubber injection channel on the tube mold through a diversion channel.

50. The transfer molding mold according to claim 49, wherein the tube mold comprises a left tube mold and a right tube mold that can be mounted to match each other; or the tube mold comprises a left tube mold, a right tube mold, and a rear tube mold that can be mounted to match each other; or the tube mold comprises a left tube mold, a right tube mold, and a front tube mold that can be mounted to match each other.

51. The transfer molding mold according to claim 49, wherein the top of the tube mold and the bottom of the rubber injection guide plate have combining parts that match each other, and the rubber injection guide plate is suitable for being closed to the top of the tube mold through the combining parts.

52. The transfer molding mold according to claim 49, further comprising:
an outsole mold, having an outsole rubber injection port and an outsole mold cavity corresponding to the shape of the sole of the vulcanized rubber boot, and being used to transfer mold the sole of the vulcanized rubber boot, wherein the outsole mold has an outsole combining part, and is suitable for being closed to the top of the tube mold and the top of the rubber injection guide plate through the outsole combining part.
